(19) United States
(12) Patent Application Publication
(10) Pub. No.: US 2015/0317674 A1
(43) Pub. Date: Nov. 5, 2015

(54) METHOD AND SYSTEM FOR INCORPORATING PAYMENT DATA TO IMPROVE ONLINE ADVERTISING

(71) Applicant: MASTERCARD INTERNATIONAL INCORPORATED, Purchase, NY (US)

(72) Inventors: Debashis GHOSH, Charlotte, NC (US); Randall K. SHUKEN, Westport, CT (US)

(73) Assignee: MASTERCARD INTERNATIONAL INCORPORATED, Purchase, NY (US)

(21) Appl. No.: 14/269,685

(22) Filed: May 5, 2014

(51) Int. Cl. G06Q 30/02; G06Q 20/40

(52) U.S. Cl. CPC G06Q 30/0255; G06Q 20/40

(57) ABSTRACT

A method for identifying purchase data for advertisement suppression includes: receiving, by a receiving device, a data file originating from a computing device, wherein the data file includes at least a computer identifier associated with the computing device, a purchase identifier, and an origination time and/or date; receiving, by the receiving device, transaction data for a payment transaction, where a portion of the transaction data corresponds to the purchase identifier, wherein the transaction data includes at least purchase data and a transaction time and/or date, and wherein the transaction time and/or date is within a predetermined period of time of the origination time and/or date; and transmitting, by a transmitting device, at least the purchase data included in the received transaction data and the computer identifier for suppression of advertisements distributed to the computing device based on at least the purchase data.

### FIELD

The present disclosure relates to the suppressing of advertisements based on purchase data, specifically the use of purchase data for payment transactions made by a consumer to suppress advertisements distributed to the consumer.

### BACKGROUND

As more and more consumers are spending time connected to the Internet on a variety of computing devices, merchants and other advertisers are constantly developing new methods for distributing advertisements to consumers and for better selection of advertisements. For example, many webpages accessed via a computing device, or application programs executed by computing devices, particularly smartphones, may display one or more advertisements to a consumer. In addition, the content of these advertisements may often be based on Internet browsing history of the consumer.

However, advertisements that are selected based on a consumer's browsing history often do not take into account other beneficial factors. For example, a consumer may browse hotels for an upcoming trip, and then be presented with a variety of targeted hotel advertisements as they continue to browse the Internet or use applications on their computing device. However, once the consumer has finally made a reservation, the consumer may still continue to be presented with hotel advertisements, despite the consumer's need for a hotel having been diminished. In such an example, the consumer's need for a product or purchase may have expired, and yet the consumer may still continue to receive advertisements for such products or purchase, which may therefore be ineffective and even counterproductive in some circumstances.

Thus, there is a need for a technical solution to provide for the use of payment data corresponding to payment transactions of a consumer in the selection of advertisements for presentation to the consumer.

### SUMMARY

The present disclosure provides a description of systems and methods for identifying purchase data for advertisement suppression and the suppression of advertisements based on the purchase data.

A method for identifying purchase data for advertisement suppression includes: receiving, by a receiving device, a data file originating from a computing device, wherein the data file includes at least a computer identifier associated with the computing device, a purchase identifier, and an origination time and/or date; receiving, by the receiving device, transaction data for a payment transaction, where a portion of the transaction data corresponds to the purchase identifier, wherein the transaction data includes at least purchase data and a transaction time and/or date, and wherein the transaction time and/or date is within a predetermined period of time of the origination time and/or date; and transmitting, by a transmitting device, at least the purchase data included in the received transaction data and the computer identifier for suppression of advertisements distributed to the computing device based on at least the purchase data.

Another method for identifying purchase data for advertisement suppression includes: storing, in an account database, a plurality of account profiles, wherein each account profile includes data related to a payment account including at least an account identifier associated with the related payment account and a computer identifier associated with a computing device; receiving, by a receiving device, transaction data for a payment transaction, wherein the transaction data includes at least purchase data and an account identification; identifying, in the account database, a specific account profile where the included account identifier corresponds to the account identification included in the received transaction data; and transmitting, by a transmitting device, at least the purchase data included in the received transaction data and the computer identifier included in the identified specific account profile for suppression of advertisements distributed to the computing device based on at least the purchase data.

A method for suppressing advertisements based on purchase data includes: storing, in a memory of a computing device, a data file configured to store information including at least a computer identifier associated with the computing device; identifying, by a processing device, a purchase identifier indicating the initiation of a payment transaction involving the computing device; updating, by the processing device, the information stored in the data file to include the identified purchase identifier; transmitting, by a transmitting device, a request for purchase data, wherein the request for purchase data includes at least the updated information stored in the data file; receiving, by a receiving device, a response to the transmitted request for purchase data, wherein the response includes at least purchase data; receiving, by the receiving device, web page data including a first advertisement; and transmitting, by the transmitting device, a request for a second advertisement if the first advertisement corresponds to the received purchase data.

A system for identifying purchase data for advertisement suppression includes a receiving device and a transmitting device. The receiving device is configured to receive: a data file originating from a computing device, wherein the data file includes at least a computer identifier associated with the computing device, a purchase identifier, and an origination time and/or date; and transaction data for a payment transaction, where a portion of the transaction data corresponds to the purchase identifier, wherein the transaction data includes at least purchase data and a transaction time and/or date, and wherein the transaction time and/or date is within a predetermined period of time of the origination time and/or date. The transmitting device is configured to transmit at least the purchase data included in the received transaction data and the computer identifier for suppression of advertisements distributed to the computing device based on at least the purchase data.

Another system for identifying purchase data for advertisement suppression includes an account database, a receiving device, a processing device, and a transmitting device. The account database is configured to store a plurality of account profiles, wherein each account profile includes data related to a payment account including at least an account identifier associated with the related payment account and a computer identifier associated with a computing device. The receiving device is configured to receive transaction data for a payment transaction, wherein the transaction data includes at least purchase data and an account identification. The processing device is configured to identify, in the account database, a specific account profile where the included account identifier corresponds to the account identification included in the received transaction data. The transmitting device is configured to transmit at least the purchase data included in the received transaction data and the computer identifier included in the identified specific account profile for suppression of advertisements distributed to the computing device based on at least the purchase data.

A system for suppressing advertisements based on purchase data includes a memory, a processing device, a transmitting device, and a receiving device. The memory, of a computing device, is configured to store a data file configured to store information including at least a computer identifier associated with the computing device. The processing device is configured to: identify a purchase identifier indicating the initiation of a payment transaction involving the computing device; and update the information stored in the data file to include the identified purchase identifier. The transmitting device is configured to transmit a request for purchase data, wherein the request for purchase data includes at least the updated information stored in the data file. The receiving device is configured to receive: a response to the transmitted request for purchase data, wherein the response includes at least purchase data; and web page data including a first advertisement. The transmitting device is further configured to transmit a request for a second advertisement if the first advertisement corresponds to the received purchase data.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying purchase data for advertisement suppression in accordance with exemplary embodiments.

FIG. 2 is a block diagram illustrating the processing server of FIG. 1 for the identifying of purchase data for advertisement suppression in accordance with exemplary embodiments.

FIG. 3 is a block diagram illustrating the computing device of FIG. 1 for the suppression of advertisements based on purchase data in accordance with exemplary embodiments.

FIG. 4 is a flow diagram illustrating a process for identifying purchase data for advertisement suppression and use thereof using the system of FIG. 1 in accordance with exemplary embodiments.

FIG. 5 is a flow diagram illustrating a process for identifying purchase data for advertisement suppression using the processing device of FIG. 2 in accordance with exemplary embodiments.

FIG. 6 is a flow diagram illustrating a process for suppression advertisements based on purchase data using the computing device of FIG. 3 in accordance with exemplary embodiments.

FIGS. 7 and 8 are flow charts illustrating exemplary methods for identifying purchase data for advertisement suppression in accordance with exemplary embodiments.

FIG. 9 is a flow chart illustrating an exemplary method for suppressing advertisements based on purchase data in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

### System for Identifying Purchase Data and Use Thereof for Advertisement Suppression

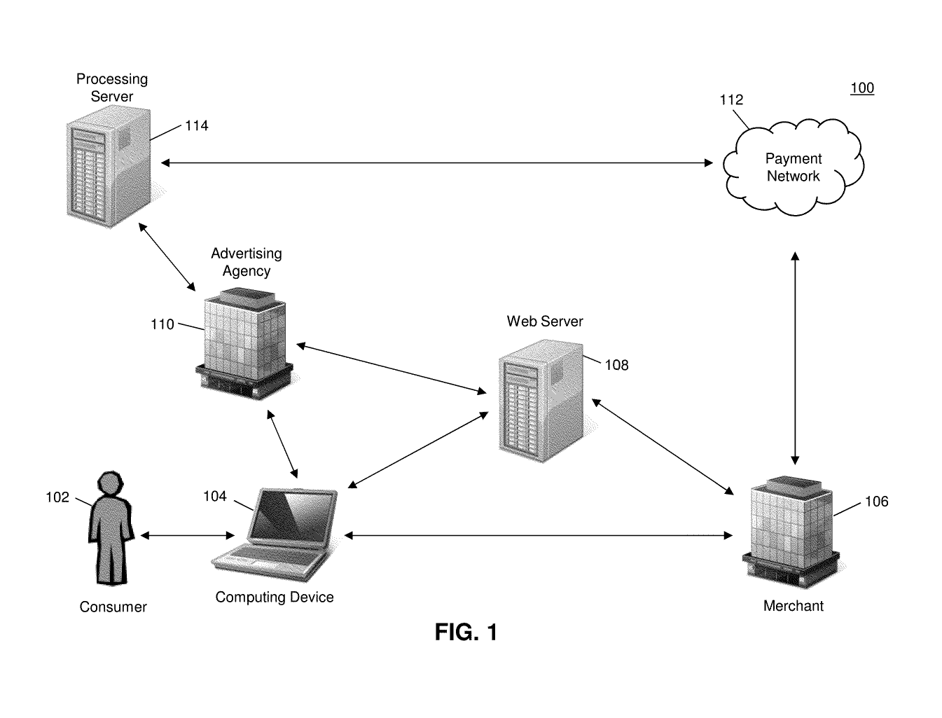

FIG. 1 illustrates a system 100 for the identifying of purchase data for use in suppressing advertisements on a computing device.

The system 100 may include a consumer 102. The consumer 102 may access the Internet or other similar network using a computing device 104. The computing device 104, discussed in more detail below, may be any suitable type of computing device configured to perform the functions as disclosed herein as will be apparent to persons having skill in the relevant art, such as a desktop computer, laptop computer, notebook computer, tablet computer, cellular phone, smartphone, etc. The consumer 102 may use the computing device 104 to visit webpages or use application programs associated with one or more merchants 106.

Visited webpages may be hosted by one or more web servers 108. Similarly, application programs may be provided be one or more entities, similar to the web servers 108. The visited webpages or application programs may include advertisements that are presented to the consumer 102 via the computing device 104. Advertising content may be provided to the web server 108 or other similar entity, or directly to the computing device 104, by computing systems of an advertising agency 110. Methods for delivering advertising content to a computing device 104 for display to a consumer 102 will be apparent to persons having skill in the relevant art.

The advertising agency 110 may select advertisements based on a browsing history of the consumer 102. The browsing history of the consumer 102 may be the history of webpages visited, application programs executed, and/or actions taken on visited webpages and executed application programs, using the computing device 104. The history may be stored locally in the computing device 104, and obtained by the advertising agency 110 and/or the web server 108, or may be stored locally in the advertising agency 110 and/or web server 108. The advertising agency 110 may analyze the browsing history of the consumer 102 and may identify targeted advertising based on the browsing history. For example, the browsing history of the consumer 102 may indicate that the consumer 102 has been reviewing hotel availability for a specific time period and location, and the advertising agency 110 may therefore select hotel advertisements for display to the consumer 102.

As part of the activity of the consumer 102, the consumer 102 may conduct payment transactions with the one or more merchants 106. The payment transactions may be conducted remotely, such as Internet transactions conducted using the computing device 104, or may be in-person transactions, such as at a physical location of the merchant 106. The payment transactions may be processed by one or more payment networks 112. Methods and systems for processing payment transactions will be apparent to persons having skill in the relevant art.

The payment networks 112 may provide transaction data for the payment transactions involving the consumer 102 to a processing server 114. The processing server 114, discussed in more detail below, may identify the transaction data of each payment transaction involving the consumer 102 to identify data included therein for use in suppressing advertisements presented to the consumer 102. The processing server 114 may then transmit the identified data to the advertising agency 110. In some embodiments, the processing server 114 may be a part of the payment network 112. The advertising agency 110 may then suppress one or more advertisements that may have otherwise been provided to the computing device 104 for display to the consumer 102, based on the consumer's purchase history.

For instance, in the example above, the consumer 102 may browse for hotel availability, and then purchase a hotel reservation. The processing server 114 may receive transaction data for the hotel reservation purchase, and may forward the data to the advertising agency 110. The advertising agency 110 may then know to suppress future advertisements for hotel accommodations, since the consumer 102 has already purchased a hotel reservation. In some embodiments, advertisements may be suppressed on product data, merchant data, or other suitable data included in transaction data.

In some instances, the processing server 114 may transmit purchase data for the payment transactions involving the consumer 102 directly to the computing device 104, such as in response to a request from the computing device 104 for the purchase data. The computing device 104 may then identify advertisement content received from the advertising agency 110 and/or the web server 108 as corresponding to the purchase data. If a correspondence is identified (e.g., if the advertisement corresponds to a previously made purchase of the consumer 102), then the computing device 104 may request an alternative advertisement for display to the consumer 102.

In the methods and systems discussed herein, advertisements displayed to the consumer 102 may be suppressed based on purchase data of the consumer 102 corresponding to payment transactions involving the consumer 102. By using purchase data to suppress advertisements, targeted advertising may be improved by displaying fresh advertisements to consumers and not displaying advertisements that correspond to purchase already made by a consumer. As a result, consumers may receive more suitable advertising, which may both improve the consumer's browsing experience, as well as increase the conversion rate of advertisements for merchants and other advertisers.

### Processing Server

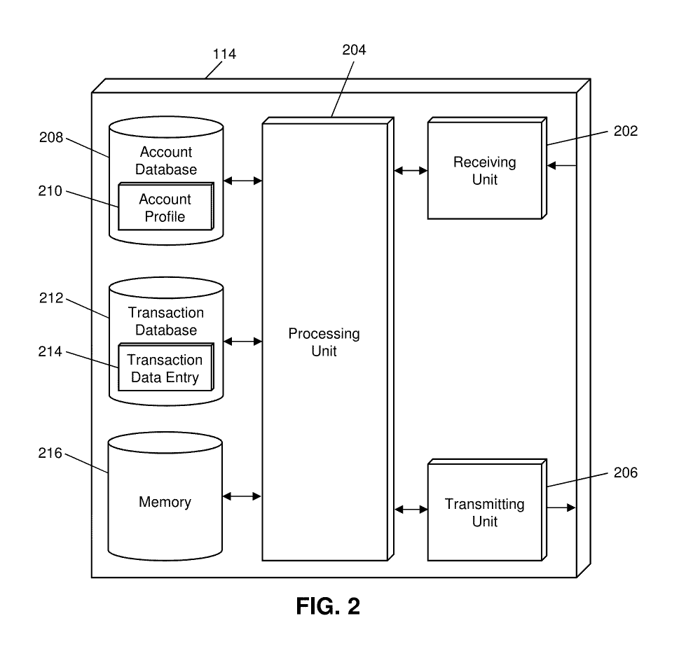

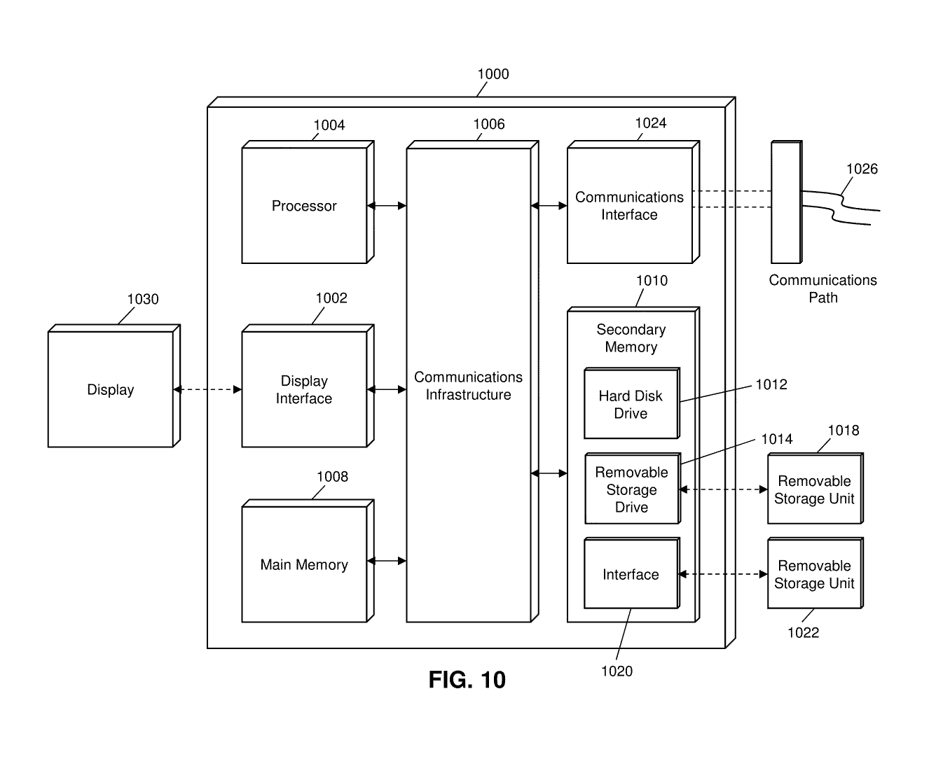

FIG. 2 illustrates an embodiment of the processing server 114 of the system 100. It will be apparent to persons having skill in the relevant art that the embodiment of the processing server 114 illustrated in FIG. 2 is provided as illustration only and may not be exhaustive to all possible configurations of processing server 114 suitable for performing the functions as discussed herein. For example, the computer system 1000 illustrated in FIG. 10 and discussed in more detail below may be a suitable configuration of the processing server 114.

The processing server 114 may include a receiving unit 202. The receiving unit 202 may be configured to receive data over one or more networks via one or more network protocols. The receiving unit 202 may receive a data file from the computing device 104 that includes at least a computer identifier associated with the computing device 104, a purchase identifier, and an origination time and/or date. The computer identifier may be a unique identification value associated with the computing device 104, such as a media access control (MAC) address, internet protocol (IP) address, serial number, registration number, username, email address, or other suitable value.

The purchase identifier may be a unique identification value associated with the consumer 102 that may be used to identify payment transactions involving the consumer 102, such as an account number, identification number, username, email address, phone number, etc. The origination time and/or date may be a time and/or date when the data file is created, updated, transmitted, received, etc. In some instances, the origination time and/or date may be identified by the processing server 114 upon receipt of the data file and included therein.

The receiving unit 202 may also be configured to receive transaction data for one or more payment transactions involving the consumer 102. A portion of the transaction data for each payment transaction may include the purchase identifier corresponding to the consumer 102 and included in the received data file. The transaction data for each payment transaction may also include purchase data and a transaction time and/or date. The transaction time and/or date may be within a predetermined period of time of the origination time and/or date. The purchase data may include merchant data, a merchant identifier, a merchant name, product data, one or more product identifiers, one or more product names, an industry identifier, an industry category, and location data.

The processing server 114 may also include an account database 208. The account database 208 may be configured to store a plurality of account profiles 210. Each account profile 210 may include data related to a payment account including at least an account identifier associated with the related payment account, and a computer identifier. The account identifier may be a unique value suitable for identification of the respective account profile 210 and/or related payment account, such as an account number, consumer identifier, username, email address, etc.

In some embodiments, the processing server 114 may also include a transaction database 212. The transaction database 212 may be configured to store a plurality of transaction data entries 214. Each transaction data entry 214 may include data related to a payment transaction including an account identifier and/or purchase identifier, a transaction time and/or date, and purchase data. The processing server 114 may include a processing unit 204. The processing unit 204 may be configured to generate a transaction data entry 214 for storage in the transaction database 212 based on the transaction data for each payment transaction received by the receiving unit 202.

The processing unit 204 may also be configured to identify an account profile 210 stored in the account database 208 that corresponds to a payment account involved in the payment transactions corresponding to the received transaction data. For instance, the processing unit 204 may identify the account identifier or purchase identifier included in the received transaction data, and may identify an account profile 210 stored in the account database 208 that includes the same account identifier or purchase identifier.

In some embodiments, the processing unit 204 may be configured to update the received data file to include the purchase data included in the transaction data received by the receiving unit 202. In other embodiments, the processing unit 204 may generate a data file that includes at least the purchase data and the computer identifier included in the identified account profile 210.

The processing server 114 may also include a transmitting unit 206. The transmitting unit 206 may be configured to transmit data over one or more networks via one or more network protocols. The transmitting unit 206 may transmit the generated or updated data file to the computing device 104 for use in suppressing advertisements based on the purchase data included therein. The generated or updated data file may be transmitted to the computing device 104 via the included computer identifier. In some embodiments, the transmitting unit 206 may transmit the purchase data identified by the processing unit 204 and the computer identifier included in the received data file or identified account profile 210 to the advertising agency 110 and/or web server 108, which may then be used to suppress advertisements provided to the computing device 104.

The processing server 114 may also include a memory 216. The memory 216 may be configured to store data suitable for performing the functions disclosed herein, as will be apparent to persons having skill in the relevant art. For example, the memory 216 may be configured to store program code for one or more application programs to be executed by the processing unit 204, such as for the generation of data files including purchase data.

### Computing Device

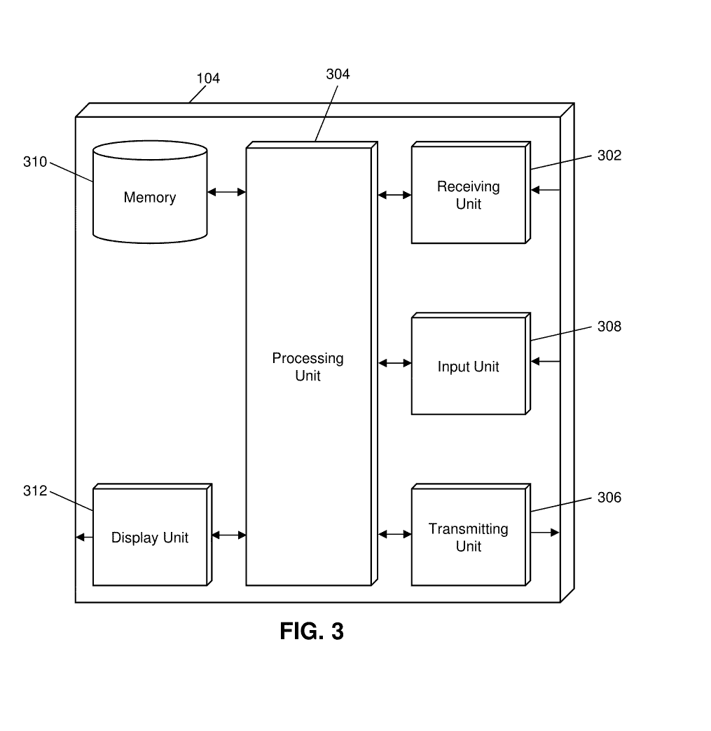

FIG. 3 illustrates an embodiment of the computing device 104 of the system 100. It will be apparent to persons having skill in the relevant art that the embodiment of the computing device 104 illustrated in FIG. 3 is provided as illustration only and may not be exhaustive to all possible configurations of computing device 104 suitable for performing the functions as discussed herein. For example, the computer system 1000 illustrated in FIG. 10 and discussed in more detail below may be a suitable configuration of the computing device 104.

The computing device 104 may include a receiving unit 302. The receiving unit 302 may be configured to receive data over one or more networks via one or more network protocols. The receiving unit 302 may receive webpage data for one or more webpages and/or program code for one or more application programs. Received webpage data may be displayed to the consumer 102 of the computing device 104 via a display unit 312. The display unit 312 may be any type of display suitable for displayed data to a consumer 102, such as a liquid crystal display, light-emitting diode display, capacitive touch screen display, etc.

Received program code may be stored in a memory 310 of the computing device 104. The computing device 104 may also include a processing unit 304. The processing unit 304 may be configured to execute the received and stored program code, which may include the execution of one or more application programs, which may result in data being displayed to the consumer 102 via the display unit 312. Application programs and webpages displayed by the display unit 312 to the consumer 102 may include advertisements, which may be included in the data received by the receiving unit 302. In some embodiments, the advertisements may be based on purchase data of the consumer 102.

The memory 310 may also be configured to store a data file, such as a cookie. The data file may include at least a computer identifier associated with the computing device 104, and may also include browsing history or any other suitable data as will be apparent to persons having skill in the relevant art. In some embodiments, the data file may also include a purchase identifier or account identifier associated with the consumer 102. In some instances, the purchase identifier may be included in the data file by the processing unit 204 upon initiation of a payment transaction including the purchase identifier, such as on a webpage or in an application program.

The computing device 104 may also include a transmitting unit 306. The transmitting unit 306 may be configured to transmit data over one or more networks via one or more network protocols. The transmitting unit 306 may transmit the data file stored in the memory 310 to the processing server 114, advertising agency 110, and/or web server 108.

The receiving unit 302 may receive purchase data from the processing server 114. The purchase data may be included in transaction data for one or more payment transactions processed by the payment network 112 and involving the consumer 102. The processing unit 304 may be configured to identify an advertisement received by the receiving unit 302 as corresponding to the received purchase data. In some embodiments, the received advertisement may include content data, which may be compared to the received purchase data. The transmitting unit 306 may be configured to transmit a request for a second advertisement if the first received advertisement corresponds to the purchase data (e.g., if the advertisement corresponds to a previous purchase made by the consumer 102). The receiving unit 302 may receive the second advertisement, which may then be displayed by the display unit 312.

The computing device 104 may also include an input unit 308. The input unit 308 may be configured to receive data input by the consumer 102 or other user or service. The input unit 308 may be a keyboard, mouse, click wheel, scroll wheel, touch screen, microphone, camera, or other suitable type of input as will be apparent to persons having skill in the relevant art. The input unit 308 may receive, for example, a uniform resource locator (URL) from the consumer 102 for navigating to a webpage, an instruction to execute an application program, etc. The input unit 308 may also receive input of a purchase identifier for use in conducting a payment transaction using the computing device 104, which may subsequently be included in the data file stored in the memory 210 by the processing unit 204.

### Process for Suppressing Advertisements Based on Purchase Data

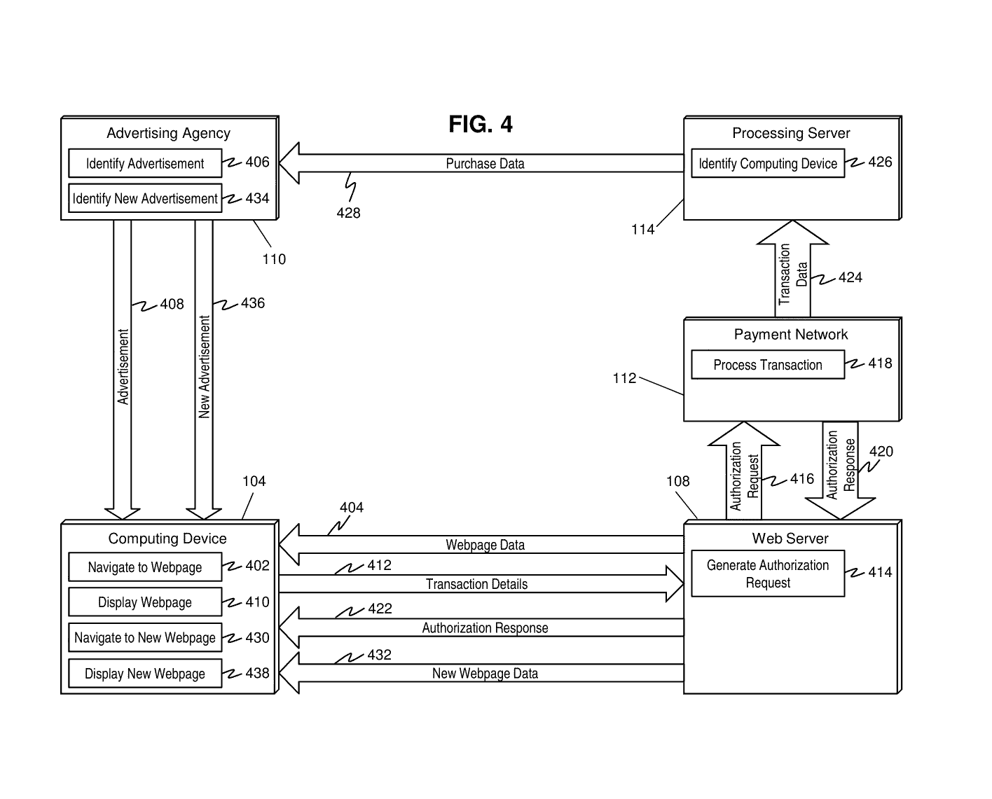

FIG. 4 illustrates a process for the suppressing of advertisements displayed on the computing device 104 based on purchase data of the consumer 102 using the system 100.

In step 402, the computing device 104 may navigate to a webpage. The webpage may be a webpage associated with a merchant 106 that may be used for the purchase of goods or services. As part of the navigation to the webpage, in step 404, the web server 108 may transmit webpage data 404 to the computing device 104. The webpage data may indicate that an advertisement is to be displayed to the consumer 102. The advertisement may be identified by the advertising agency 110, in step 406. Then, in step 408, the advertisement may be transmitted to the computing device 104.

In step 410, the webpage, including the received advertisement, may be displayed to the consumer via the display unit 312 of the computing device 104. In step 412, the consumer 102 may initiate a payment transaction using the webpage (e.g., via the input unit 308), which may include the submitting of transaction details for the payment transaction, including payment data (e.g., a purchase identifier and/or account identifier), to the web server 108. In step 414, the web server 108 may generate an authorization request for the payment transaction. In some embodiments, the transaction data may be forwarded to the merchant 106 and/or an acquirer associated with the merchant 106 by the web server 108 for use in generating the authorization request.

In step 416, the authorization request may be submitted to the payment network 112. In step 418, the payment network 112 may process the payment transaction using methods and systems that will be apparent to persons having skill in the relevant art. In step 420, an authorization response indicating approval of the payment transaction may be transmitted by the payment network 112 back to the web server 108 (e.g., via the merchant 106 and/or an acquirer). In step 422, the authorization response or other indication of approval of the payment transaction may be transmitted to the computing device 104, such as via a webpage indicating approval of the payment transaction.

In step 424, the payment network 112 may transmit transaction data for the processed payment transaction to the processing server 114. In step 426, the processing server 114 may identify the computing device 104 as being involved in the payment transaction. In one embodiment, the computing device 104 may be identified via an account profile 210 including the computer identifier associated with the computing device 104. In another embodiment, the computing device 104 may be identified via a data file including the computer identifier associated with the computing device 104 and a purchase identifier included in the received transaction data. In step 428, purchase data included in the transaction data, and the computer identifier, may be transmitted to the advertising agency 110.

In step 430, the computing device 104 may navigate to a new webpage. In step 432, the web server 108 may transmit webpage data for the new webpage to the computing device 104. In step 434, the advertising agency 110 may identify a new advertisement for display to the consumer 102. The new advertisement may be identified based on suppression of potential advertisements based on the received purchase data. The new advertisement may be transmitted to the computing device 104, in step 436. In step 438, the computing device 104 may display the new webpage to the consumer 102, which may include the new advertisement selected based on the purchase data of the consumer 102.

### Process for Identifying Purchase Data

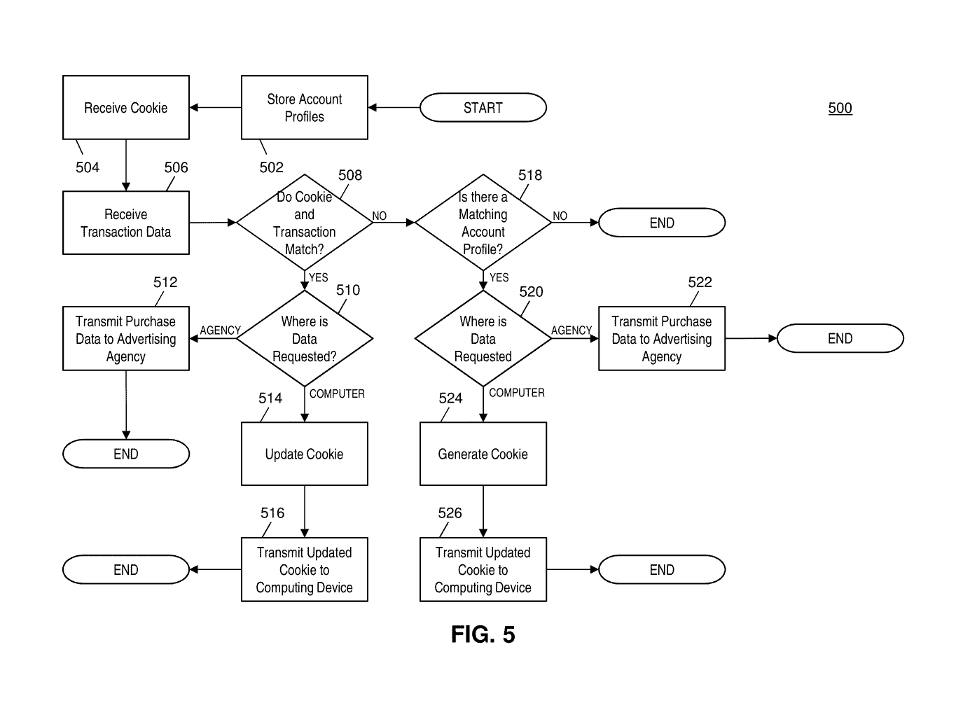

FIG. 5 illustrates a process 500 for the identification of purchase data by the processing server 114 for use in advertisement suppression.

In step 502, a plurality of account profiles 210 may be stored in the account database 208. Each account profile 210 may include data related to a payment account including at least an account identifier associated with the related payment account and a computer identifier associated with a computing device 104. In step 504, the receiving unit 202 of the processing server 114 may receive a cookie. The cookie may include at least a specific computer identifier associated with a specific computing device 104 and may also include an account identifier associated with a payment account.

In step 506, the receiving unit 202 may receive transaction data. The transaction data may include data related to a payment transaction including at least a specific account identifier associated with a payment account involved in the related payment transaction and purchase data. In step 508, the processing unit 204 of the processing server 114 may determine if the received cookie matches the received transaction data. The determination may be based on the account identifier included in the cookie and the specific account identifier included in the received transaction data.

If the processing unit 204 determines that the cookie matches the transaction, then, in step 510, may identify where the purchase data is to be transmitted. If the purchase data is being requested by the advertising agency 110, then, in step 512, the transmitting unit 206 of the processing server 114 may transmit the purchase data included in the received transaction data to the advertising agency 110. If the purchase data is being requested by the computing device 104, then, in step 514, the processing unit 204 may update the cookie to include the purchase data. In step 516, the transmitting unit 206 may transmit the updated cookie back to the computing device 104.

If, in step 508, the processing unit 204 determines that the cookie and payment transaction do not match, such as in instances where the cookie may not include an account identifier, then, in step 518, the processing unit 204 may determine if there is an account profile 210 that indicates a match. The determination may be based on identification of an account profile 210 that includes both the specific account identifier included in the received transaction data and the computer identifier included in the received cookie. If no such account profile 210 exists, then the process 500 may be completed as the transaction data may not be matched to a specific computing device 104.

If an account profile 210 is identified, then, in step 520, the processing unit 204 may determine where the purchase data is to be transmitted. If the purchase data is requested by the advertising agency 110, then, in step 522, the purchase data, including the computer identifier associated with the computing device 104, may be transmitted to the advertising agency 110 by the transmitting unit 206. If the purchase data is requested by the computing device 104, then, in step 524, the processing unit 204 may generate a cookie including the purchase data, or update the previously received cookie to include the purchase data. In step 526, the transmitting unit 206 may transmit the cookie to the computing device 104.

### Process for Suppressing Advertisements

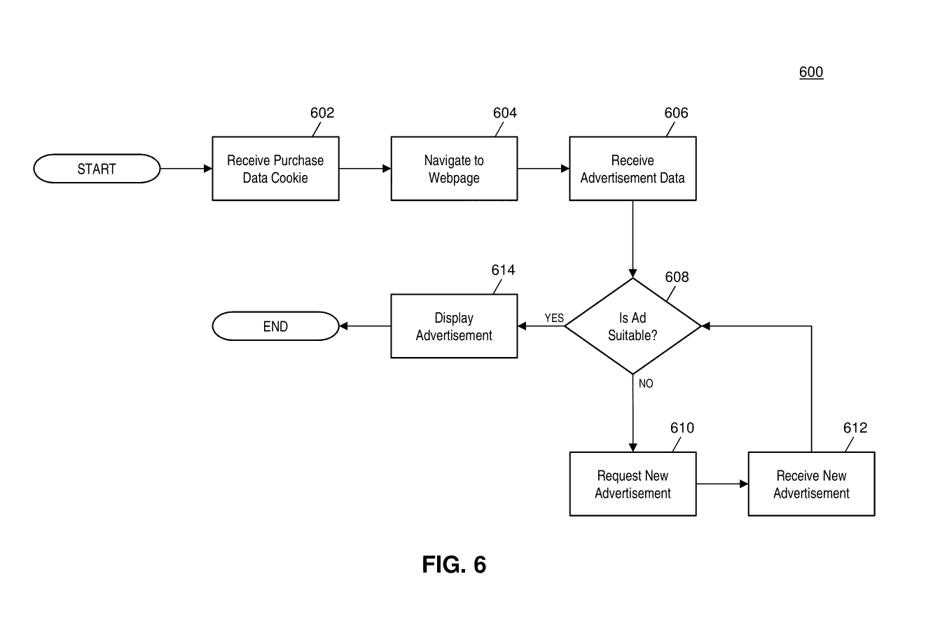

FIG. 6 illustrates a process 600 for the identification of suppressing of advertisements by the computing device 104 based on purchase data.

In step 602, the receiving unit 302 of the computing device 104 may receive a cookie from the processing server 114 that includes purchase data from one or more payment transactions involving the consumer 102. In step 604, the computing device 104 may navigate to a webpage, such as based on input received from the consumer 102 via the input unit 308 of the computing device 104. In step 606, the receiving unit 302 may receive advertisement data from the advertising agency 110 and/or the web server 108.

In step 608, the processing unit 304 of the computing device 104 may determine if the received advertisement is suitable. The received advertisement may not be suitable if it corresponds to a purchase already made by the consumer 102 based on the purchase data included in the received cookie. The correspondence may be based on the content of the advertisement itself, data accompanying the advertisement, or any other suitable method for correlating an advertisement to purchase data. For example, the advertisement may include (e.g., be encoded with, accompanied by, associated with, etc.) merchant data, industry data, product data, etc. The processing unit 304 may compare the data with the purchase data to identify any correspondences, matches, etc. to determine if the advertisement corresponds to a purchase already made by the consumer 102.

If the advertisement is not suitable (e.g., it corresponds to a purchase), then, in step 610, the transmitting unit 306 of the computing device 104 may transmit a request to the web server 108 and/or advertising agency 110 for a new advertisement. In step 612, the receiving unit 302 may receive the new advertisement. The process 600 may then return to step 608, to determine if the new advertisement is suitable. Once a suitable advertisement has been received, then, in step 614, the display unit 312 may display the advertisement with the webpage.

In some embodiments, the advertisement data received in step 606 may include data for a plurality of advertisements. In such an embodiment, steps 610 and 612 may include selecting the next advertisement from the plurality of advertisements received in step 606. In this instance, steps 608 to 614 may thereby be conducted by the computing device 104 without requiring communication with an outside system or device, which may enable a suitable advertisement to be selected quickly and without additional requests to the web server 108 or advertising agency 110.

### First Exemplary Method for Identifying Purchase Data for Advertisement Suppression

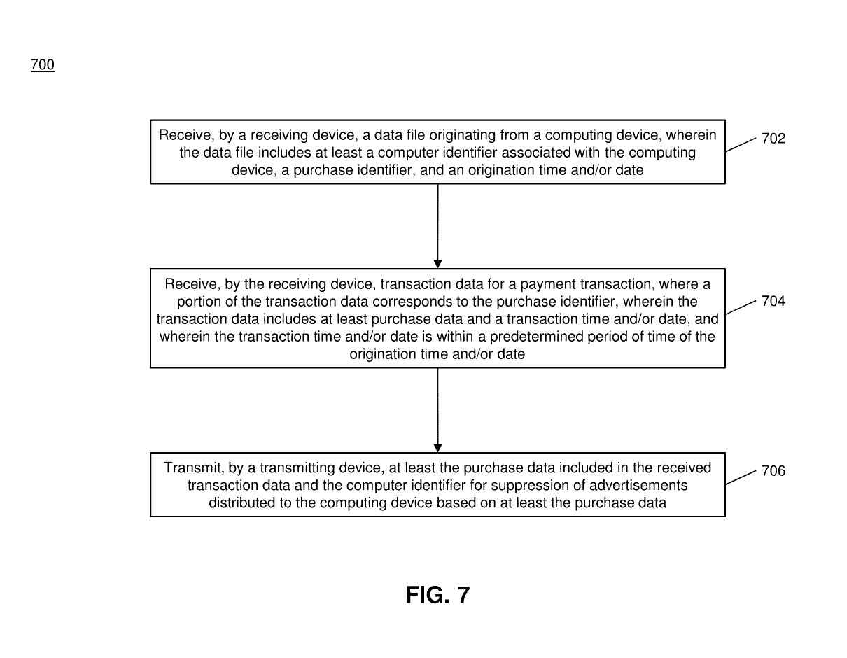

FIG. 7 illustrates a method 700 for the identification of purchase data for use in advertisement suppression.

In step 702, a data file may be received, by a receiving device (e.g., the receiving unit 202), originating from a computing device (e.g., the computing device 104), wherein the data file includes at least a computer identifier associated with the computing device 104, a purchase identifier, and an origination time and/or date. In some embodiments, the purchase identifier may include at least one of: a payment account number, a merchant identifier, a merchant name, a consumer identifier, a username, an IP address, a MAC address, and a URL.

In step 704, transaction data may be received, by the receiving device 202, for a payment transaction, where a portion of the transaction data corresponds to the purchase identifier, wherein the transaction data includes at least purchase data and a transaction time and/or date, and wherein the transaction time and/or date is within a predetermined period of time of the origination time and/or date. In some embodiments, receiving transaction data for a payment transaction includes receiving an authorization request for the payment transaction, the authorization request including at least the transaction data.

In one embodiment, the portion of the transaction data includes at least one of: a payment account number, a merchant identifier, a merchant name, a consumer identifier, a username, an IP address, a MAC address, and a URL. In some embodiments, the purchase data may include at least one of: merchant data, a merchant identifier, a merchant name, product data, one or more product identifiers, one or more product names, an industry identifier, an industry category, and location data.

In step 706, at least the purchase data included in the received transaction data and the computer identifier may be transmitted, by a transmitting device (e.g., the transmitting unit 206) for suppression of advertisements distributed to the computing device 104 based on at least the purchase data. In one embodiment, the method 700 may further include updating, by a processing device (e.g., the processing unit 204), the received data file to include the purchase data, wherein transmitting at least the purchase data included in the received transaction data and the computer identifier includes transmitting the updated data file to the computing device 104.

### Second Exemplary Method for Identifying Purchase Data for Advertisement Suppression

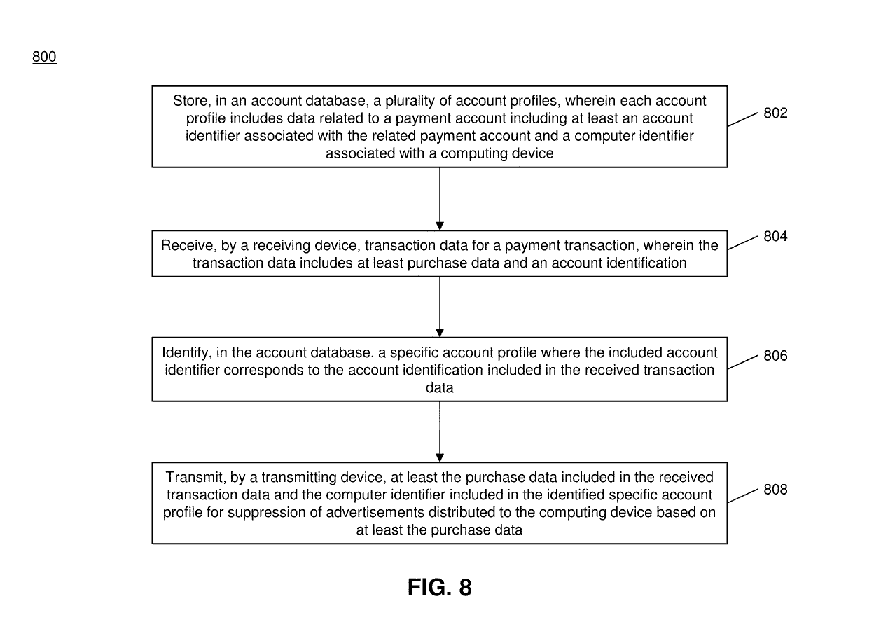

FIG. 8 illustrates a method 800 for the identification of purchase data for use in advertisement suppression.

In step 802, a plurality of account profiles (e.g., account profiles 210) may be stored in an account database (e.g., the account database 208), wherein each account profile 210 includes data related to a payment account including at least an account identifier associated with the related payment account and a computer identifier associated with a computing device (e.g., the computing device 104). In one embodiment, the account identifier may include at least one of: a payment account number, a merchant identifier, a merchant name, a consumer identifier, a username, an IP address, a MAC address, and a URL.

In step 804, transaction data for a payment transaction may be received by a receiving device (e.g., the receiving unit 302), wherein the transaction data includes at least purchase data and an account identification. In some embodiments, the purchase data may include at least one of: merchant data, a merchant identifier, a merchant name, product data, one or more product identifiers, one or more product names, an industry identifier, an industry category, and location data. In one embodiment, receiving transaction data for a payment transaction may include receiving an authorization request for the payment transaction, the authorization request including at least the transaction data.

In step 806, a specific account profile 210 may be identified in the account database 208 where the included account identifier corresponds to the account identification included in the received transaction data. In step 808, at least the purchase data included in the received transaction data and the computer identifier included in the identified specific account profile 210 may be transmitted, by a transmitting device (e.g., the transmitting unit 206) for suppression of advertisements distributed to the computing device 104 based on at least the purchase data.

In one embodiment, the method 800 may further include generating, by a processing device (e.g., the processing unit 204), a data file including at least the purchase data included in the received transaction data and the computer identifier included in the identified specific account profile 210, wherein transmitting at least the purchase data included in the received transaction data and the computer identifier included in the identified specific account profile 210 includes transmitting the generated data file to the computing device 104 associated with the computer identifier.

### Exemplary Method for Suppressing Advertisements Based on Purchase Data

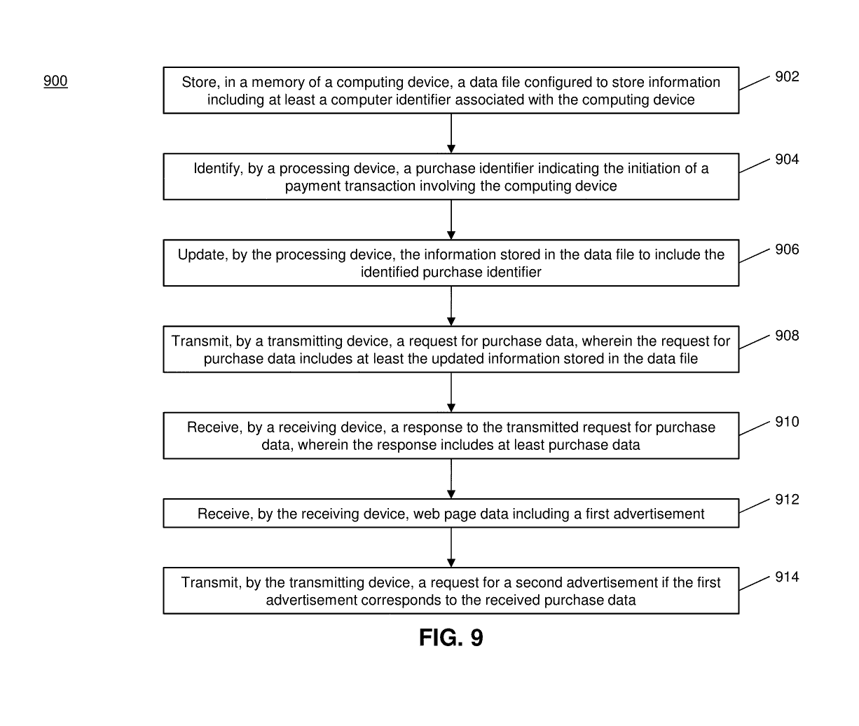

FIG. 9 illustrates a method 900 for suppressing advertisements displayed on a computing device based on purchase data associated with a user of the computing device.

In step 902, a data file may be stored in a memory (e.g., the memory 310) of a computing device (e.g., the computing device 104), wherein the data file is configured to store information including at least a computer identifier associated with the computing device 104. In step 904, a purchase identifier may be identified, by a processing device (e.g., the processing unit 304), indicating the initiation of a payment transaction involving the computing device 104. In one embodiment, the purchase identifier may include at least one of: a payment account number, a merchant identifier, a merchant name, a consumer identifier, a username, an IP address, a MAC address, and a URL.

In step 906, the information stored in the data file may be updated, by the processing device 304, to include the identified purchase identifier. In step 908, a request for purchase data may be transmitted by a transmitting device (e.g., the transmitting unit 306), wherein the request for purchase data includes at least the updated information stored in the data file.

In step 910, a response to the transmitted request for purchase data may be received by a receiving device (e.g., the receiving unit 302), wherein the response includes at least purchase data. In one embodiment, the purchase data may include at least one of: merchant data, a merchant identifier, a merchant name, product data, one or more product identifiers, one or more product names, an industry identifier, an industry category, and location data.

In step 912, web page data including a first advertisement may be received by the receiving device 302. In step 914, a request for a second advertisement may be transmitted by the transmitting device 306 if the first advertisement corresponds to the received purchase data. In one embodiment, method 900 may further include: receiving, by the receiving device 302, new web page data including a second advertisement; and displaying, by a display device (e.g., the display unit 312), the new web page data including the second advertisement.

### Computer System Architecture

FIG. 10 illustrates a computer system 1000 in which embodiments of the present disclosure, or portions thereof, may be implemented as computer-readable code. For example, the processing server 114 and computing device 104 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (HDMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 4-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for the identification of purchase data and use thereof for advertisement suppression. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying purchase data for advertisement suppression, comprising:
receiving, by a receiving device, a data file originating from a computing device, wherein the data file includes at least a computer identifier associated with the computing device, a purchase identifier, and an origination time and/or date;
receiving, by the receiving device, transaction data for a payment transaction, where a portion of the transaction data corresponds to the purchase identifier, wherein the transaction data includes at least purchase data and a transaction time and/or date, and wherein the transaction time and/or date is within a predetermined period of time of the origination time and/or date; and
transmitting, by a transmitting device, at least the purchase data included in the received transaction data and the computer identifier for suppression of advertisements distributed to the computing device based on at least the purchase data.

2. The method of claim 1, wherein the portion of the transaction data includes at least one of: a payment account number, a merchant identifier, a merchant name, a consumer identifier, a username, an internet protocol address, a media access control address, and a uniform resource locator.

3. The method of claim 1, wherein the purchase identifier includes at least one of: a portion of a payment account number, a merchant identifier, a merchant name, a consumer identifier, a username, an internet protocol address, a media access control address, and a uniform resource locator.

4. The method of claim 1, further comprising:
updating, by a processing device, the received data file to include at least the purchase data, wherein
transmitting at least the purchase data included in the received transaction data and the computer identifier includes transmitting the updated data file to the computing device.

5. The method of claim 1, wherein the purchase data includes at least one of: merchant data, a merchant identifier, a merchant name, product data, one or more product identifiers, one or more product names, an industry identifier, an industry category, and location data.

6. The method of claim 1, wherein receiving transaction data for a payment transaction includes receiving an authorization request for the payment transaction, the authorization request including at least the transaction data.

7. A method for identifying purchase data for advertisement suppression, comprising:
storing, in an account database, a plurality of account profiles, wherein each account profile includes data related to a payment account including at least an account identifier associated with the related payment account and a computer identifier associated with a computing device;
receiving, by a receiving device, transaction data for a payment transaction, wherein the transaction data includes at least purchase data and an account identification;
identifying, in the account database, a specific account profile where the included account identifier corresponds to the account identification included in the received transaction data; and
transmitting, by a transmitting device, at least the purchase data included in the received transaction data and the computer identifier included in the identified specific account profile for suppression of advertisements distributed to the computing device based on at least the purchase data.

8. The method of claim 7, wherein the account identifier includes at least one of: a payment account number, a merchant identifier, a merchant name, a consumer identifier, a username, an internet protocol address, a media access control address, and a uniform resource locator.

9. The method of claim 7, further comprising:
generating, by a processing device, a data file including at least the purchase data included in the received transaction data and the computer identifier included in the identified specific account profile, wherein
transmitting at least the purchase data included in the received transaction data and the computer identifier included in the identified specific account profile includes transmitting the generated data file to the computing device associated with the computer identifier.

10. The method of claim 7, wherein the purchase data includes at least one of: merchant data, a merchant identifier, a merchant name, product data, one or more product identifiers, one or more product names, an industry identifier, an industry category, and location data.

11. The method of claim 7, wherein receiving transaction data for a payment transaction includes receiving an authorization request for the payment transaction, the authorization request including at least the transaction data.

12. A method for suppressing advertisements based on purchase data, comprising:
storing, in a memory of a computing device, a data file configured to store information including at least a computer identifier associated with the computing device;
identifying, by a processing device, a purchase identifier indicating the initiation of a payment transaction involving the computing device;
updating, by the processing device, the information stored in the data file to include the identified purchase identifier;
transmitting, by a transmitting device, a request for purchase data, wherein the request for purchase data includes at least the updated information stored in the data file;
receiving, by a receiving device, a response to the transmitted request for purchase data, wherein the response includes at least purchase data;
receiving, by the receiving device, web page data including a first advertisement; and
transmitting, by the transmitting device, a request for a second advertisement if the first advertisement corresponds to the received purchase data.

13. The method of claim 12, wherein the purchase identifier includes at least one of: a portion of a payment account number, a merchant identifier, a merchant name, a consumer identifier, a username, an internet protocol address, a media access control address, and a uniform resource locator.

14. The method of claim 12, wherein the purchase data includes at least one of: merchant data, a merchant identifier, a merchant name, product data, one or more product identifiers, one or more product names, an industry identifier, an industry category, and location data.

15. The method of claim 12, further comprising:
receiving, by the receiving device, new web page data including a second advertisement; and
displaying, by a display device, the new web page data including the second advertisement.

16. A system for identifying purchase data for advertisement suppression, comprising:
a receiving device configured to receive
a data file originating from a computing device, wherein the data file includes at least a computer identifier associated with the computing device, a purchase identifier, and an origination time and/or date, and
transaction data for a payment transaction, where a portion of the transaction data corresponds to the purchase identifier, wherein the transaction data includes at least purchase data and a transaction time and/or date, and wherein the transaction time and/or date is within a predetermined period of time of the origination time and/or date; and
a transmitting device configured to transmit at least the purchase data included in the received transaction data and the computer identifier for suppression of advertisements distributed to the computing device based on at least the purchase data.

17. The system of claim 16, wherein the portion of the transaction data includes at least one of: a payment account number, a merchant identifier, a merchant name, a consumer identifier, a username, an internet protocol address, a media access control address, and a uniform resource locator.

18. The system of claim 16, wherein the purchase identifier includes at least one of: a portion of a payment account number, a merchant identifier, a merchant name, a consumer identifier, a username, an internet protocol address, a media access control address, and a uniform resource locator.

19. The system of claim 16, further comprising:
a processing device configured to update the received data file to include at least the purchase data, wherein
transmitting at least the purchase data included in the received transaction data and the computer identifier includes transmitting the updated data file to the computing device.

20. The system of claim 16, wherein the purchase data includes at least one of: merchant data, a merchant identifier, a merchant name, product data, one or more product identifiers, one or more product names, an industry identifier, an industry category, and location data.

21. The system of claim 16, wherein receiving transaction data for a payment transaction includes receiving an authorization request for the payment transaction, the authorization request including at least the transaction data.

22. A system for identifying purchase data for advertisement suppression, comprising:
an account database configured to store a plurality of account profiles, wherein each account profile includes data related to a payment account including at least an account identifier associated with the related payment account and a computer identifier associated with a computing device;
a receiving device configured to receive transaction data for a payment transaction, wherein the transaction data includes at least purchase data and an account identification;
a processing device configured to identify, in the account database, a specific account profile where the included account identifier corresponds to the account identification included in the received transaction data; and
a transmitting device configured to transmit at least the purchase data included in the received transaction data and the computer identifier included in the identified specific account profile for suppression of advertisements distributed to the computing device based on at least the purchase data.

23. The system of claim 22, wherein the account identifier includes at least one of: a payment account number, a merchant identifier, a merchant name, a consumer identifier, a username, an internet protocol address, a media access control address, and a uniform resource locator.

24. The system of claim 22, wherein
the processing device is further configured to generate a data file including at least the purchase data included in the received transaction data and the computer identifier included in the identified specific account profile, and
transmitting at least the purchase data included in the received transaction data and the computer identifier included in the identified specific account profile includes transmitting the generated data file to the computing device associated with the computer identifier.

25. The system of claim 22, wherein the purchase data includes at least one of: merchant data, a merchant identifier, a merchant name, product data, one or more product identifiers, one or more product names, an industry identifier, an industry category, and location data.

26. The system of claim 22, wherein receiving transaction data for a payment transaction includes receiving an authorization request for the payment transaction, the authorization request including at least the transaction data.

27. A system for suppressing advertisements based on purchase data, comprising:
a memory of a computing device configured to store a data file configured to store information including at least a computer identifier associated with the computing device;
a processing device configured to
identify a purchase identifier indicating the initiation of a payment transaction involving the computing device, and
update the information stored in the data file to include the identified purchase identifier;
a transmitting device configured to transmit a request for purchase data, wherein the request for purchase data includes at least the updated information stored in the data file; and
a receiving device configured to receive
a response to the transmitted request for purchase data, wherein the response includes at least purchase data, and
web page data including a first advertisement, wherein
the transmitting device is further configured to transmit a request for a second advertisement if the first advertisement corresponds to the received purchase data.

28. The system of claim 27, wherein the purchase identifier includes at least one of: a portion of a payment account number, a merchant identifier, a merchant name, a consumer identifier, a username, an internet protocol address, a media access control address, and a uniform resource locator.

29. The system of claim 27, wherein the purchase data includes at least one of: merchant data, a merchant identifier, a merchant name, product data, one or more product identifiers, one or more product names, an industry identifier, an industry category, and location data.

30. The system of claim 27, further comprising:
a display device, wherein
the receiving device is further configured to receive new web page data including a second advertisement, and
the display device is configured to display the new web page data including the second advertisement.
